(19) United States
(12) Patent Application Publication
(10) Pub. No.: US 2024/0219537 A1
(43) Pub. Date: Jul. 4, 2024

(54) SENSOR CALIBRATION ROBOT

(71) Applicant: GM Cruise Holdings LLC, San Francisco, CA (US)

(72) Inventor: Julian Charles, San Francisco, CA (US)

(21) Appl. No.: 18/093,308

(22) Filed: Jan. 4, 2023

(51) Int. Cl. G01S 7/497; B60W 60/00; G05D 1/02

(52) U.S. Cl. CPC G01S 7/497; B60W 60/001; G05D 1/0246; G05D 1/028; B60W 2420/52

(57) ABSTRACT

The present disclosure generally relates to sensor calibration using a robot cart, and more specifically, to sensor calibration using a robot that is configured to automatically reposition a calibration target. In some aspects, the present disclosure provides a process for determining a first location of a calibration robot within a calibration environment, collecting a first set of sensor data for the calibration environment, and transmitting a relocation command to the calibration robot. In some aspects, the process can further include steps for collecting, using the one or more AV sensors, a second set of sensor data for the calibration environment, wherein the second set of sensor data includes the calibration robot at the second location. Systems and computer-readable media are also provided.

### BACKGROUND

### 1. Technical Field

The present disclosure generally relates to sensor calibration and more specifically, to solutions for characterizing sensor performance using a robot to automatically adjust (or relocate) sensor calibration targets in a test environment.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide a safe and efficient transportation. Such tasks may require the collection and processing of large quantities of data using various sensor types, including but not limited to cameras and/or Light Detection and Ranging (LiDAR) sensors disposed on the AV.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system for implementing sensor calibration using a robot cart, according to some aspects of the present disclosure:

FIG. 2 illustrates another example system for implementing sensor calibration using a robot cart, according to some aspects of the present disclosure

FIG. 3 illustrates an example of a communication process between a calibration system and a robot cart, according to some aspects of the present disclosure:

FIG. 4 illustrates an example of a process for sensor calibration using a robot cart, according to some aspects of the present disclosure:

FIG. 5 illustrates an example system environment that can be used to facilitate autonomous vehicle (AV) navigation and routing operations, according to some aspects of the present disclosure; and

FIG. 6 illustrates an example processor-based system with which some aspects of the subject technology can be implemented, according to some aspects of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the environment and move without human input. Automation technology enables the AVs to drive on roadways and to perceive the surrounding environment accurately and quickly, including obstacles, signs, and traffic lights. In some cases, AVs can be used to pick up passengers and drive the passengers to selected destinations.

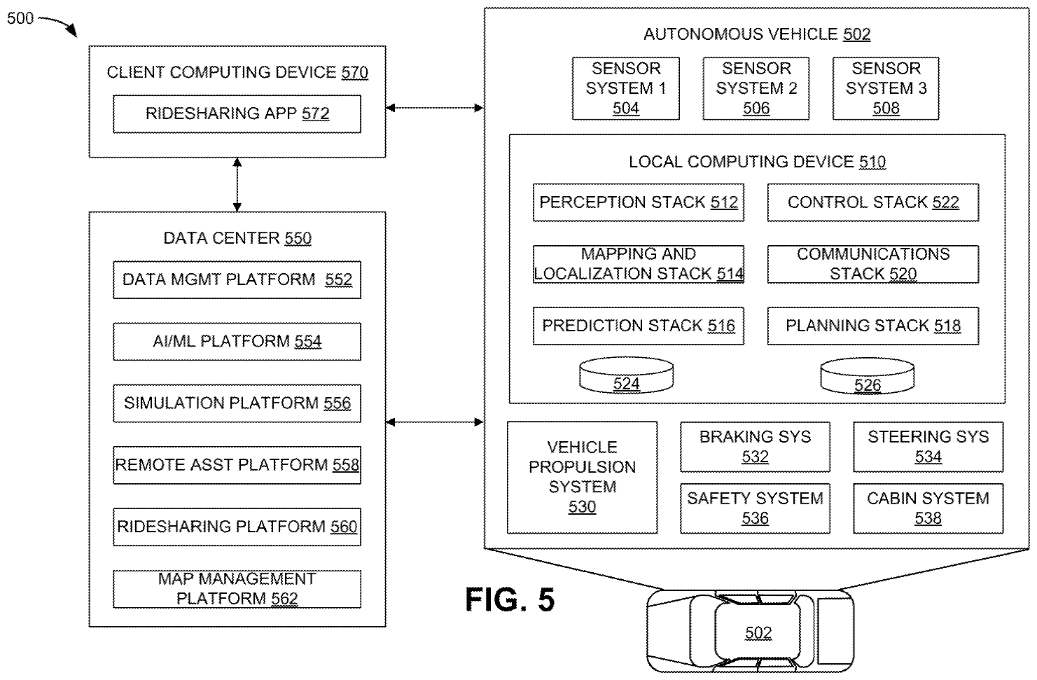

Autonomous vehicles may contain multiple sensor systems (which will be discussed in further detail in FIG. 5 below) including, but not limited to, Inertial Measurement Units (IMUs), still image and video cameras, light sensors (e.g., LiDAR), and RADAR systems. AV sensor systems are required to function in different environments that the AV may potentially encounter. For example, a LiDAR system emits light particles (i.e., photons) that hit nearby objects such as other cars, pedestrians, and objects. The photons then return or “bounce back” to the LiDAR sensor. The LiDAR system measures each photon's roundtrip data measuring distance and time to every object in the AV's vicinity which results in a 3D representation of the surrounding environment. In some examples, the LiDAR system may have a range of 250-400 meters, which enables the AV to identify objects and their respective positions.

In some examples, LiDAR sensor performance may be characterized from multiple parameters including, but not limited to, range precision, range accuracy, average intensity, and probability of detection. Additionally, camera sensor performance may be characterized using any of a variety of image quality parameters, including but not limited to brightness, hue, saturation, and the like. Those skilled in the art will appreciate additional sensor parameters for AV sensor systems. The sensor system is a critical element in the function of the AV, enabling the vehicle to sense the surrounding environment without human intervention. In the development of AV sensor systems, characterizing the functionality and performance of a sensor system (e.g., how well a LiDAR sensor can capture an object at a large distance) in addition to calibrating the sensor system requires significant testing including placing targets at various positions. For example, in the case of testing the performance of a LiDAR system, a target can be a reflector or a fiducial placed at different distances and locations. During these types of tests, a person is often required to manually move the target from one location to another. Consequently, this may slow down the testing and data collection process since large amounts of man-hours are required to move the target to different positions in a test environment.

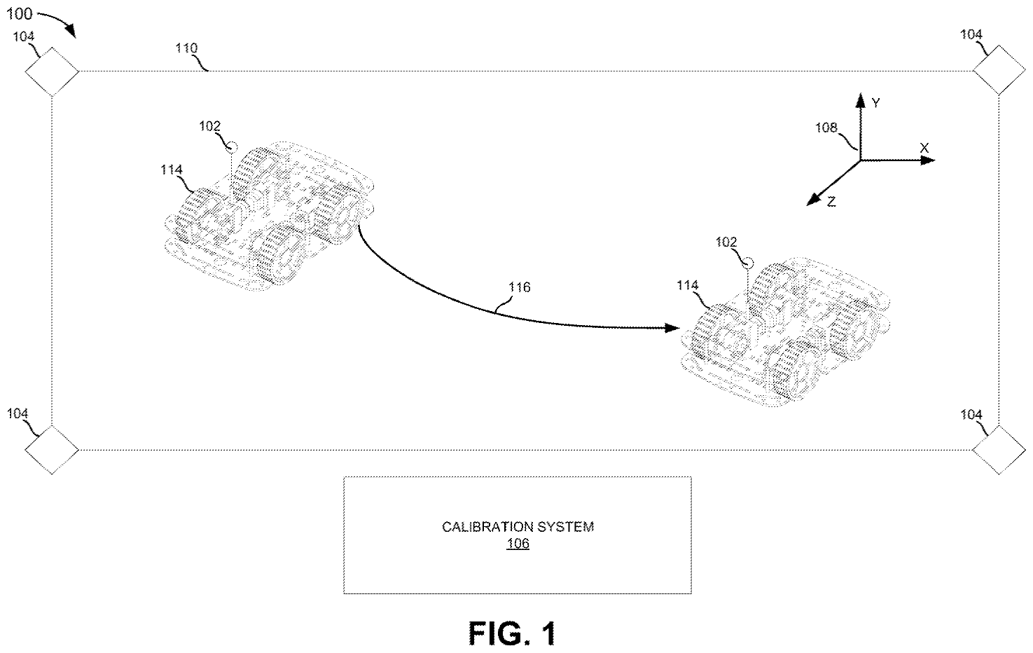

Aspects of the disclosed invention provide solutions for automating various sensor calibration and testing processes using a robot cart. In some aspects, a robot cart (also robotic cart, calibration robot) may include a target and computer system connected to a network. The robot cart may be remotely controlled to move to different locations, thereby repositioning/relocating the calibration target, e.g., without the need for human intervention. Consequently, the process of collecting sensor data for use in performing extrinsic sensor calibrations is faster than manually moving the target from one location to another. The robot cart may be oriented and moved in 3-dimensions (which will be discussed in further detail in FIG. 1 below), allowing the target to change orientation and position accordingly. In some cases, the calibration environment (or test environment), e.g., the area in which the robot cart may be moved, may be mapped so that the position (i.e., coordinates or location within the test environment) of the robot cart are accurately determined.

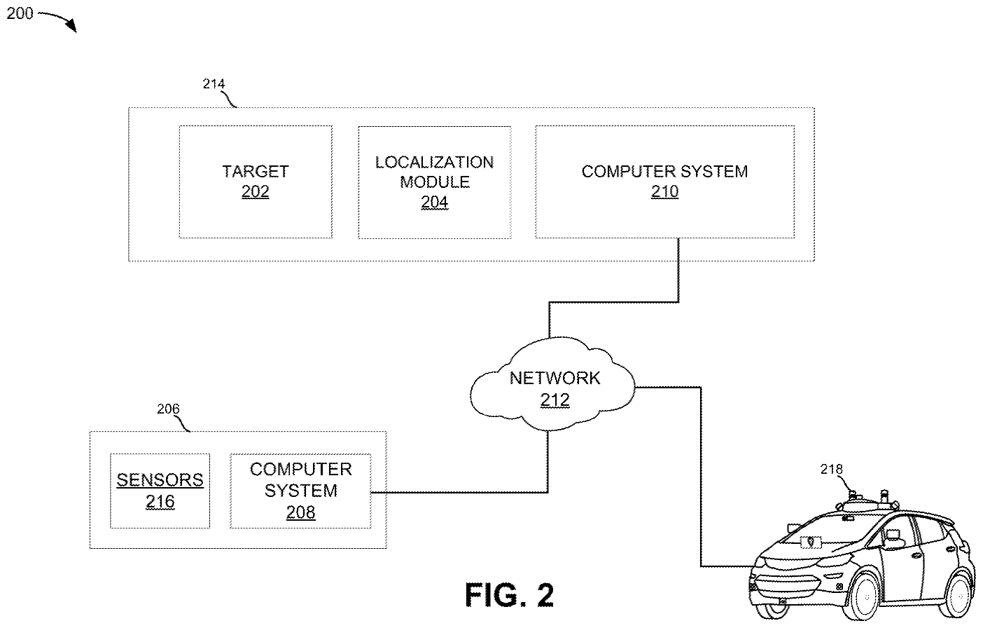

FIG. 1 illustrates an example test scene 100 in which a robot cart sensor calibration process of the disclosed technology may be implemented. Test scene 100 includes a test environment (also calibration environment or sensor characterization environment) 110, robot cart 114 (which will be discussed in further detail in FIG. 2 below), calibration system 106 (which will be discussed in further detail in FIG. 2 below), and one or more markers 104. In some aspects, calibration system 106 may map the test environment 110 using markers 104, where the markers 104 may be an object type that corresponds to the type of sensor in calibration system 106 (e.g., for a LiDAR sensor the marker 104 can be a fiducial or reflector, for a camera sensor the marker 104 can be a checkerboard patterned or optical calibration object, etc.). The markers 104 may be located in various areas within test environment 110. Mapping test environment 110 may enable calibration system 106 to know the location of robot cart 114 within test environment 110. For example, calibration system 106 may include LiDAR and markers 104 can be reflectors (also fiducials) at fixed locations which provide data (e.g., the angle and intensity of the photons reflected to calibration system 106) required for calibration system 106 to map the test environment 110. The robot cart 114 may include one or more targets 102 which may correlate to the sensor type in calibration system 106. For example, if calibration system 106 includes LiDAR sensors and markers 104 are reflectors (also fiducials), then target 102 may also be a reflector. To determine calibration parameters for the LiDAR sensors, calibration system 106 may calculate the first location (i.e., current location) of robot cart 114 based on the sensor data or the reflection received from target 102 (i.e., reflector or fiducial). In some cases, robot cart 114 may not include a target, and calibration system 106 may calculate the first location of robot cart 114 based off another feature of robot cart 114. The robot cart 114 may include a localization module and computer system (which will be discussed in further detail in FIG. 2 below) which can transmit the first location of robot cart 114 to calibration system 106. Sensor system's 106 calculated location of robot cart 114 may be compared with the first location received from robot cart 114. If sensor system's 106 calculated location of robot cart 114 is similar (i.e., within a specified tolerance) to the first location transmitted by robot cart 114, then it may be determined that the LiDAR sensor is properly calibrated. Conversely, if the calculated location differs from the transmitted first location from robot cart 114, then the LiDAR sensor may be improperly calibrated. A similar process of mapping and sensor calibration can be performed for other sensor types (i.e., AV sensors) with different markers 104 and target 102. For example, if calibration system 106 includes a camera, then markers 104 and target 102 may be a checkerboard patterned object, optical calibration target, or any object which enables a camera to perform the same process above as discussed with LiDAR.

Next, calibration system 106 may transmit instructions, or a relocation command, to robot cart 114 to move locations within test environment 110. In other words, the relocation command may instruct robot cart 114 to navigate from the current first location to a second location as shown by trajectory 116. In some aspects, robot cart 114 can be instructed to move to any location within test environment 110. The process of comparing the calculated location of robot cart 114 with the location received from robot cart 114 to subsequently calibrate sensors within calibration system 106 as described at the first location above may also be performed with the robot cart 114 at the second location.

In some aspects, robot cart 114 may rotate or orient itself in 3-dimensions 108. The robot cart 114 may also raise above the ground level (e.g., via suspension systems) along with target 102 (e.g., to raise or lower target 102 to a desired height or elevation). Consequently, this may allow calibration system 106 additional types of sensor calibration/characterization and testing by receiving data on sensor performance over multiple positions in the vertical direction. For example, for LiDAR characterization, it may be important to compare sensor data collected from various targets 102 that are positioned at the same or similar heights. By enabling robot cart 114 to adjust/re-position its elevation, the robot cart 114 can be used to facilitate sensor characterizations between multiple/different targets 102 in the test environment 110. Additionally, robot cart 114 may include or receive a software script to automatically move over a pre-programmed path to further automate the sensor calibration and testing process.

FIG. 2 illustrates another example test scene 200 in which a robot cart sensor calibration process of the disclosed technology may be implemented. In some aspects, robot cart 214 may include target 202, localization module 204, and computer system 210. In some cases, calibration system 206 may include one or more sensors 216 (e.g., sensor systems 504, 506, and 508 as illustrated in FIG. 5) and computer system 208. Both computer system 210 and computer system 208 may include transceivers including but not limited to, a WIFI antenna, cellular antenna and Bluetooth®. Computer system 210 and computer system 208 may be connected to a network 212 (e.g., WIFI and cellular as discussed in further detail in FIG. 5 below) which may have internet connectivity. In addition, an external device 218 including but not limited to an AV or another computer at an external location may also be connected to network 212 or another network (not shown) with internet access.

As discussed above in FIG. 1, calibration system 206 may transmit a relocation command to robot cart 214 (along with target 202, localization module 204 and computer system 210) to change locations or navigate from a first location to a second location. This may occur via computer system 208 transmitting instructions to computer system 210 (e.g., via a WIFI antenna). Next, computer system 210 may instruct robot cart's 214 propulsion system, braking system and steering system (e.g., vehicle propulsion system 530, braking system 532, and steering system 534 illustrated in FIG. 5) to navigate from the first location to the second location as instructed by computer system 208. For example, robot cart 214 may include DC motors to power the wheels to navigate within the test environment (e.g., test environment 110 as discussed above in FIG. 1). In some cases, external device 218 may also instruct computer system 210 to move locations. Localization module 204 can determine the location of robot cart 214 by utilizing navigation devices including, but not limited to, Global Navigation Satellite System (GNSS) and/or Inertial Navigation System (INS) sensors.

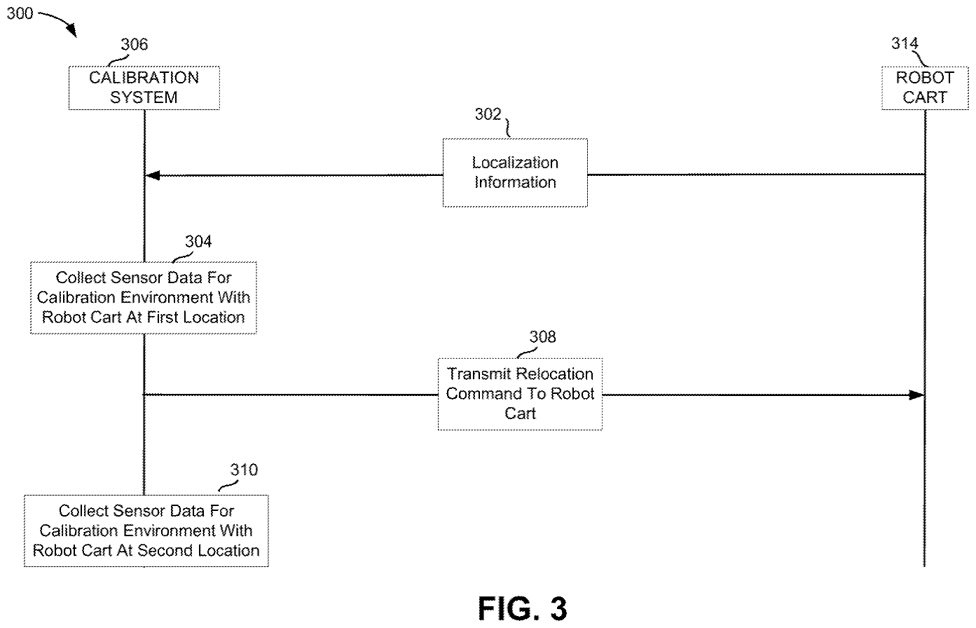

FIG. 3 illustrates an example communication process 300 between a calibration system 306 and a robot cart 314, according to some aspects of the present disclosure. The process begins with robot cart 314 transmitting its respective localization information 302 to calibration system. For example, localization information can be determined from a GNSS receiver or Inertial Navigation System on the robot cart 314. Next, the process 300 continues with step 304, for the calibration system 306 to collect sensor data for the calibration environment with the robot cart 314 at a first location. The calibration system 306 may use one or more AV sensors (e.g., sensors 216 as illustrated in FIG. 2) to collect sensor data pertaining to the calibration environment, such as test environment 110 described above in FIG. 1. The AV sensors may interact (e.g., LiDAR sensor can transmit and receive a laser, a camera can take a picture) with the robot cart 314 at the first location and receive sensor data which may enable the calibration system 306 to estimate a location of robot cart 314. Next, the process 300 continues to step 308 where the calibration system 306 can transmit a relocation command to robot cart 314. For example, calibration system 306 can transmit (e.g., using a WIFI antenna) a second location for the robot cart 314 to navigate to. Finally, the process 300 continues to step 310, for the calibration system 306 to collect sensor data for the calibration environment with the robot cart 314 at a second location. The calibration system 306 may also use AV sensors to interact with the robot cart 314 as described above with the robot cart 314 at the second location, so that the calibration 306 may estimate a location of the robot cart 314 at the second location.

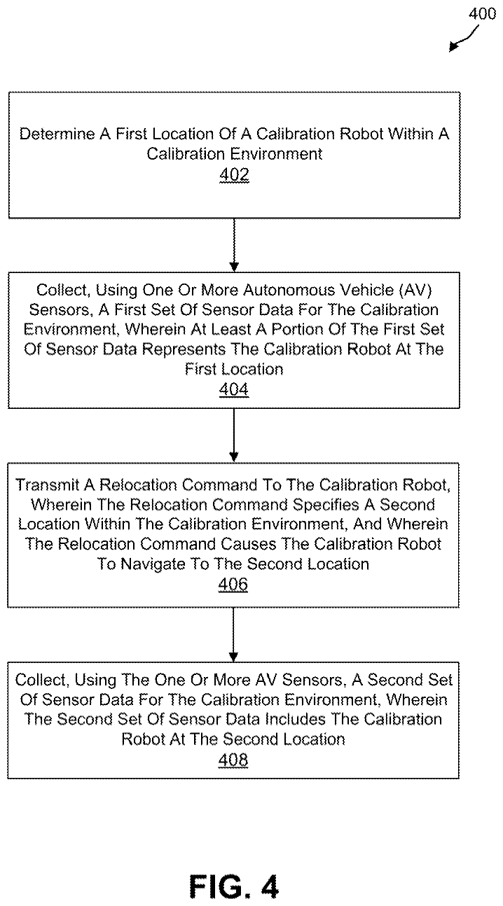

FIG. 4 illustrates an example of a process 400 for sensor calibration using a robot cart, according to some aspects of the present disclosure. At block 402, the process 400 includes determining a first location of a calibration robot within a calibration environment. For example, localization module 204 may transmit location information of the robot cart 214 (also calibration robot) to calibration system 206.

At block 404, the process 400 includes collecting, using one or more autonomous vehicle (AV) sensors, a first set of sensor data for the calibration environment, wherein at least a portion of the first set of sensor data represents the calibration robot at the first location. For example, sensors 216 of calibration system 206 may collect sensor data pertaining to the calibration environment (e.g., test environment 110). The sensors 216 may interact (e.g., a LiDAR sensor may transmit a laser and receive a reflection) with the calibration robot at the first location and consequently receive sensor data.

At block 406, the process 400 includes transmitting a relocation command to the calibration robot, wherein the relocation command specifies a second location within the calibration environment, and wherein the relocation command causes the calibration robot to navigate to the second location. For example, computer system 208 may include a WIFI antenna to transmit a relocation command to the calibration robot to navigate to a second location within the calibration environment.

At block 408, the process 400 includes collecting, using the one or more AV sensors, a second set of sensor data for the calibration environment, wherein the second set of sensor data includes the calibration robot at the second location. For example, after the calibration robot receives a relocation command from the calibration system 206, sensors 216 can interact with the calibration robot at the second location and consequently receive sensor data

In some cases, the process 400 can include determining one or more extrinsic calibration parameters for the one or more AV sensors based on the first set of sensor data and the first location of the calibration robot. For example, calibration system 206 may use the sensor data (e.g., for LiDAR, the angle and intensity of the photons reflected to calibration system 206 from target 202) to calculate a location of robot cart 214. Next, calibration system 206 may compare the calculated location of robot cart 214 with the first location received from localization module 204. If the calculated location from calibration system 206 is within proximity (i.e., a specified tolerance) to the first location received from localization module 204, then it may be determined that sensors 216 are properly calibrated. Conversely, if the calculated location from calibration system 206 is not within proximity (i.e., a specified tolerance) to the first location received from location module 204, then it may be determined that sensors 216 are improperly calibrated.

In some cases, the process 400 can include determining one or more extrinsic calibration parameters for the one or more AV sensors based on the second set of sensor data and the second location of the calibration robot. For example, computer system 208 may transmit a relocation command to the calibration robot to navigate from the first location to a second location. The comparison between the calculated location by calibration system 206 with the second location received from localization module 204 may be performed as described above (e.g., the process as described above with the calibration robot at the first location) to calibrate sensors 216.

FIG. 5 illustrates an example of an AV management system 500. One of ordinary skill in the art will understand that, for the AV management system 500 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill in the art will appreciate that such variations do not depart from the scope of the present disclosure.

In this example, the AV management system 500 includes an AV 502, a data center (also autonomous vehicle fleet management device, autonomous vehicle fleet management system, management system) 550, and a client computing device 570. The AV 502, the data center 550, and the client computing device 570 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 502 can navigate roadways without a human driver based on sensor signals generated by multiple sensor systems 504, 506, and 508. The sensor systems 504-508 can include different types of sensors and can be arranged about the AV 502. For instance, the sensor systems 504-508 can comprise Inertial Measurement Units (IMUs), cameras (e.g., still image cameras, video cameras, etc.), light sensors (e.g., LiDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LiDAR system, and the sensor system 508 can be a RADAR system. Other embodiments may include any other number and type of sensors.

The AV 502 can also include several mechanical systems that can be used to maneuver or operate the AV 502. For instance, the mechanical systems can include a vehicle propulsion system 530, a braking system 532, a steering system 534, a safety system 536, and a cabin system 538, among other systems. The vehicle propulsion system 530 can include an electric motor, an internal combustion engine, or both. The braking system 532 can include an engine brake, brake pads, actuators, and/or any other suitable componentry configured to assist in decelerating the AV 502. The steering system 534 can include suitable componentry configured to control the direction of movement of the AV 502 during navigation. The safety system 536 can include lights and signal indicators, a parking brake, airbags, and so forth. The cabin system 538 can include cabin temperature control systems, in-cabin entertainment systems, and so forth. In some embodiments, the AV 502 might not include human driver actuators (e.g., steering wheel, handbrake, foot brake pedal, foot accelerator pedal, turn signal lever, window wipers, etc.) for controlling the AV 502. Instead, the cabin system 538 can include one or more client interfaces (e.g., Graphical User Interfaces (GUIs), Voice User Interfaces (VUIs), etc.) for controlling certain aspects of the mechanical systems 530-538.

The AV 502 can additionally include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 502; communicating with the data center 550), the client computing device 570), and other systems; receiving inputs from riders, passengers, and other entities within the AV's environment; logging metrics collected by the sensor systems 504-508; and so forth. In this example, the local computing device 510 includes a perception stack 512, a mapping and localization stack 514, a prediction stack 516, a planning stack 518, a communications stack 520, a control stack 522, an AV operational database 524, and an HD geospatial database 526, among other stacks and systems.

The perception stack 512 can enable the AV 502 to “see” (e.g., via cameras, LiDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the mapping and localization stack 514, the HD geospatial database 526, other components of the AV, and other data sources (e.g., the data center 550), the client computing device 570, third party data sources, etc.). The perception stack 512 can detect and classify objects and determine their current locations, speeds, directions, and the like. In addition, the perception stack 512 can determine the free space around the AV 502 (e.g., to maintain a safe distance from other objects, change lanes, park the AV, etc.). The perception stack 512 can also identify environmental uncertainties, such as where to look for moving objects, flag areas that may be obscured or blocked from view, and so forth. In some embodiments, an output of the prediction stack 516 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 514 can determine the AV's position and orientation (pose) using different methods from multiple systems (e.g., GPS, IMUs, cameras, LiDAR, RADAR, ultrasonic sensors, the HD geospatial database 526, etc.). For example, in some embodiments, the AV 502 can compare sensor data captured in real-time by the sensor systems 504-508 to data in the HD geospatial database 526 to determine its precise (e.g., accurate to the order of a few centimeters or less) position and orientation. The AV 502 can focus its search based on sensor data from one or more first sensor systems (e.g., GPS) by matching sensor data from one or more second sensor systems (e.g., LiDAR). If the mapping and localization information from one system is unavailable, the AV 502 can use mapping and localization information from a redundant system and/or from remote data sources.

The prediction stack 516 can receive information from the mapping and localization stack 514 and objects identified by the perception stack 512 and predict a future path for the objects. In some embodiments, the prediction stack 516 can output several likely paths that an object is predicted to take along with a probability associated with each path. For each predicted path, the prediction stack 516 can also output a range of points along the path corresponding to a predicted location of the object along the path at future time intervals along with an expected error value for each of the points that indicates a probabilistic deviation from that point.

The planning stack 518 can determine how to maneuver or operate the AV 502 safely and efficiently in its environment. For example, the planning stack 518 can receive the location, speed, and direction of the AV 502, geospatial data, data regarding objects sharing the road with the AV 502 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 502 from one point to another and outputs from the perception stack 512, mapping and localization stack 514, and prediction stack 516. The planning stack 518 can determine multiple sets of one or more mechanical operations that the AV 502 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 518 can select from multiple backup plans to carry out. For example, while preparing to change lanes to turn right at an intersection, another vehicle may aggressively cut into the destination lane, making the lane change unsafe. The planning stack 518 could have already determined an alternative plan for such an event. Upon its occurrence, it could help direct the AV 502 to go around the block instead of blocking a current lane while waiting for an opening to change lanes.

The control stack 522 can manage the operation of the vehicle propulsion system 530, the braking system 532, the steering system 534, the safety system 536, and the cabin system 538. The control stack 522 can receive sensor signals from the sensor systems 504-508 as well as communicate with other stacks or components of the local computing device 510 or a remote system (e.g., the data center 550)) to effectuate operation of the AV 502. For example, the control stack 522 can implement the final path or actions from the multiple paths or actions provided by the planning stack 518. This can involve turning the routes and decisions from the planning stack 518 into commands for the actuators that control the AV's steering, throttle, brake, and drive unit.

The communications stack 520 can transmit and receive signals between the various stacks and other components of the AV 502 and between the AV 502, the data center 550, the client computing device 570, and other remote systems. The communications stack 520 can enable the local computing device 510 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 520 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 526 can store HD maps and related data of the streets upon which the AV 502 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

The AV operational database 524 can store raw AV data generated by the sensor systems 504-508, stacks 512-522, and other components of the AV 502 and/or data received by the AV 502 from remote systems (e.g., the data center 550, the client computing device 570, etc.). In some embodiments, the raw AV data can include HD LiDAR point cloud data, image data, RADAR data, GPS data, and other sensor data that the data center 550) can use for creating or updating AV geospatial data or for creating simulations of situations encountered by AV 502 for future testing or training of various machine learning algorithms that are incorporated in the local computing device 510.

The data center 550 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 550 can include one or more computing devices remote to the local computing device 510 for managing a fleet of AVs and AV-related services. For example, in addition to managing the AV 502, the data center 550 may also support a ridesharing service, a delivery service, a remote/roadside assistance service, street services (e.g., street mapping, street patrol, street cleaning, street metering, parking reservation, etc.), and the like.

The data center 550 can send and receive various signals to and from the AV 502 and the client computing device 570. These signals can include sensor data captured by the sensor systems 504-508, roadside assistance requests, software updates, ridesharing pick-up and drop-off instructions, and so forth. In this example, the data center 550 includes a data management platform 552, an Artificial Intelligence/Machine Learning (AI/ML) platform 554, a simulation platform 556, a remote assistance platform 558, a ridesharing platform 560, and a map management platform 562, among other systems.

The data management platform 552 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 550 can access data stored by the data management platform 552 to provide their respective services.

The AI/ML platform 554 can provide the infrastructure for training and evaluating machine learning algorithms for operating the AV 502, the simulation platform 556, the remote assistance platform 558, the ridesharing platform 560, the map management platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

The simulation platform 556 can enable testing and validation of the algorithms, machine learning models, neural networks, and other development efforts for the AV 502, the remote assistance platform 558, the ridesharing platform 560, the map management platform 562, and other platforms and systems. The simulation platform 556 can replicate a variety of driving environments and/or reproduce real-world scenarios from data captured by the AV 502, including rendering geospatial information and road infrastructure (e.g., streets, lanes, crosswalks, traffic lights, stop signs, etc.) obtained from a cartography platform (e.g., map management platform 562); modeling the behavior of other vehicles, bicycles, pedestrians, and other dynamic elements; simulating inclement weather conditions, different traffic scenarios; and so on.

The remote assistance platform 558 can generate and transmit instructions regarding the operation of the AV 502. For example, in response to an output of the AI/ML platform 554 or other system of the data center 550, the remote assistance platform 558 can prepare instructions for one or more stacks or other components of the AV 502.

The ridesharing platform 560 can interact with a customer of a ridesharing service via a ridesharing application 572 executing on the client computing device 570. The client computing device 570 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 572. The client computing device 570 can be a customer's mobile computing device or a computing device integrated with the AV 502 (e.g., the local computing device 510). The ridesharing platform 560 can receive requests to pick up or drop off from the ridesharing application 572 and dispatch the AV 502 for the trip.

Map management platform 562 can provide a set of tools for the manipulation and management of geographic and spatial (geospatial) and related attribute data. The data management platform 552 can receive LiDAR point cloud data, image data (e.g., still image, video, etc.), RADAR data, GPS data, and other sensor data (e.g., raw data) from one or more AVs 502, Unmanned Aerial Vehicles (UAVs), satellites, third-party mapping services, and other sources of geospatially referenced data. The raw data can be processed, and map management platform 562 can render base representations (e.g., tiles (2D), bounding volumes (3D), etc.) of the AV geospatial data to enable users to view, query, label, edit, and otherwise interact with the data. Map management platform 562 can manage workflows and tasks for operating on the AV geospatial data. Map management platform 562 can control access to the AV geospatial data, including granting or limiting access to the AV geospatial data based on user-based, role-based, group-based, task-based, and other attribute-based access control mechanisms. Map management platform 562 can provide version control for the AV geospatial data, such as to track specific changes that (human or machine) map editors have made to the data and to revert changes when necessary. Map management platform 562 can administer release management of the AV geospatial data, including distributing suitable iterations of the data to different users, computing devices, AVs, and other consumers of HD maps. Map management platform 562 can provide analytics regarding the AV geospatial data and related data, such as to generate insights relating to the throughput and quality of mapping tasks.

In some embodiments, the map viewing services of map management platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ridesharing platform 560 may incorporate the map viewing services into the client application 572 to enable passengers to view the AV 502 in transit en route to a pick-up or drop-off location, and so on.

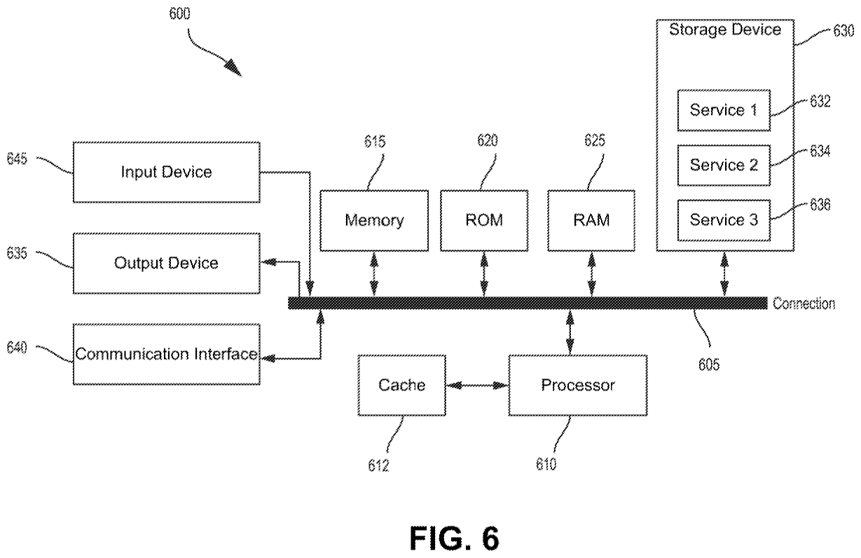

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACONR® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi R wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communications interface 640) may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick R card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Illustrative examples of the disclosure include:

Aspect 1. An apparatus for facilitating sensor calibration, comprising: at least one memory; and at least one processor coupled to the at least one memory, the at least one processor configured to: determine a first location of a calibration robot within a calibration environment; collect, using one or more autonomous vehicle (AV) sensors, a first set of sensor data for the calibration environment, wherein at least a portion of the first set of sensor data represents the calibration robot at the first location; transmit a relocation command to the calibration robot, wherein the relocation command specifies a second location within the calibration environment, and wherein the relocation command causes the calibration robot to navigate to the second location; and collect, using the one or more AV sensors, a second set of sensor data for the calibration environment, wherein the second set of sensor data includes the calibration robot at the second location.

Aspect 2. The apparatus of Aspect 1, wherein the first location of the calibration robot is based on localization information provided by a localizer disposed on the calibration robot.

Aspect 3. The apparatus of any of Aspects 1-2, wherein the localizer comprises a Global Navigation Satellite System (GNSS) localizer.

Aspect 4. The apparatus of any of Aspects 1-3, wherein the calibration robot includes an optical calibration target, and wherein the first set of sensor data comprises Light Detection and Ranging (LiDAR) sensor data for the optical calibration target.

Aspect 5. The apparatus of any of Aspects 1-4, wherein the calibration robot includes an optical calibration target, and wherein the first set of sensor data comprises camera sensor data for the optical calibration target.

Aspect 6. The apparatus of any of Aspects 1-5, wherein the at least one processor is further configured to: determine one or more extrinsic calibration parameters for the one or more AV sensors based on the first set of sensor data and the first location of the calibration robot.

Aspect 7. The apparatus of any of Aspects 1-6, wherein the at least one processor is further configured to: determine one or more extrinsic calibration parameters for the one or more AV sensors based on the second set of sensor data and the second location of the calibration robot.

Aspect 8. A computer-implemented method for facilitating sensor calibration, comprising: determining a first location of a calibration robot within a calibration environment; collecting, using one or more autonomous vehicle (AV) sensors, a first set of sensor data for the calibration environment, wherein at least a portion of the first set of sensor data represents the calibration robot at the first location; transmitting a relocation command to the calibration robot, wherein the relocation command specifies a second location within the calibration environment, and wherein the relocation command causes the calibration robot to navigate to the second location; and collecting, using the one or more AV sensors, a second set of sensor data for the calibration environment, wherein the second set of sensor data includes the calibration robot at the second location.

Aspect 9. The computer-implemented method of Aspect 8, wherein the first location of the calibration robot is based on localization information provided by a localizer disposed on the calibration robot.

Aspect 10. The computer-implemented method of any of Aspects 8-9, wherein the localizer comprises a Global Navigation Satellite System (GNSS) localizer.

Aspect 11. The computer-implemented method of any of Aspects 8-10, wherein the calibration robot includes an optical calibration target, and wherein the first set of sensor data comprises Light Detection and Ranging (LiDAR) sensor data for the optical calibration target.

Aspect 12. The computer-implemented method of any of Aspects 8-11, wherein the calibration robot includes an optical calibration target, and wherein the first set of sensor data comprises camera sensor data for the optical calibration target.

Aspect 13. The computer-implemented method of any of Aspects 8-12, further comprising: determining one or more extrinsic calibration parameters for the one or more AV sensors based on the first set of sensor data and the first location of the calibration robot.

Aspect 14. The computer-implemented method of any of Aspects 8-13, further comprising: determining one or more extrinsic calibration parameters for the one or more AV sensors based on the second set of sensor data and the second location of the calibration robot.

Aspect 15. A non-transitory computer-readable storage medium comprising at least one instruction for causing a computer or processor to: determine a first location of a calibration robot within a calibration environment; collect, using one or more autonomous vehicle (AV) sensors, a first set of sensor data for the calibration environment, wherein at least a portion of the first set of sensor data represents the calibration robot at the first location; transmit a relocation command to the calibration robot, wherein the relocation command specifies a second location within the calibration environment, and wherein the relocation command causes the calibration robot to navigate to the second location; and collect, using the one or more AV sensors, a second set of sensor data for the calibration environment, wherein the second set of sensor data includes the calibration robot at the second location.

Aspect 16. The non-transitory computer-readable storage medium of Aspect 15, wherein the first location of the calibration robot is based on localization information provided by a localizer disposed on the calibration robot.

Aspect 17. The non-transitory computer-readable storage medium of any of Aspects 15-16, wherein the localizer comprises a Global Navigation Satellite System (GNSS) localizer.

Aspect 18. The non-transitory computer-readable storage medium of any of Aspects 15-17, wherein the calibration robot includes an optical calibration target, and wherein the first set of sensor data comprises Light Detection and Ranging (LiDAR) sensor data for the optical calibration target.

Aspect 19. The non-transitory computer-readable storage medium of any of Aspects 15-18, wherein the calibration robot includes an optical calibration target, and wherein the first set of sensor data comprises camera sensor data for the optical calibration target.

Aspect 20. The non-transitory computer-readable storage medium of any of Aspects 15-19, wherein the at least one instruction is further configured to: determine one or more extrinsic calibration parameters for the one or more AV sensors based on the first set of sensor data and the first location of the calibration robot.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. An apparatus for facilitating sensor calibration, comprising:
at least one memory; and
at least one processor coupled to the at least one memory, the at least one processor configured to:
determine a first location of a calibration robot within a calibration environment;
collect, using one or more autonomous vehicle (AV) sensors, a first set of sensor data for the calibration environment, wherein at least a portion of the first set of sensor data represents the calibration robot at the first location;
transmit a relocation command to the calibration robot, wherein the relocation command specifies a second location within the calibration environment, and wherein the relocation command causes the calibration robot to navigate to the second location; and
collect, using the one or more AV sensors, a second set of sensor data for the calibration environment, wherein the second set of sensor data includes the calibration robot at the second location.

2. The apparatus of claim 1, wherein the first location of the calibration robot is based on localization information provided by a localizer disposed on the calibration robot.

3. The apparatus of claim 2, wherein the localizer comprises a Global Navigation Satellite System (GNSS) localizer.

4. The apparatus of claim 1, wherein the calibration robot includes an optical calibration target, and wherein the first set of sensor data comprises Light Detection and Ranging (LiDAR) sensor data for the optical calibration target.

5. The apparatus of claim 1, wherein the calibration robot includes an optical calibration target, and wherein the first set of sensor data comprises camera sensor data for the optical calibration target.

6. The apparatus of claim 1, wherein the at least one processor is further configured to:
determine one or more extrinsic calibration parameters for the one or more AV sensors based on the first set of sensor data and the first location of the calibration robot.

7. The apparatus of claim 1, wherein the at least one processor is further configured to:
determine one or more extrinsic calibration parameters for the one or more AV sensors based on the second set of sensor data and the second location of the calibration robot.

8. A computer-implemented method for facilitating sensor calibration, comprising:
determining a first location of a calibration robot within a calibration environment;
collecting, using one or more autonomous vehicle (AV) sensors, a first set of sensor data for the calibration environment, wherein at least a portion of the first set of sensor data represents the calibration robot at the first location;
transmitting a relocation command to the calibration robot, wherein the relocation command specifies a second location within the calibration environment, and wherein the relocation command causes the calibration robot to navigate to the second location; and
collecting, using the one or more AV sensors, a second set of sensor data for the calibration environment, wherein the second set of sensor data includes the calibration robot at the second location.

9. The computer-implemented method of claim 8, wherein the first location of the calibration robot is based on localization information provided by a localizer disposed on the calibration robot.

10. The computer-implemented method of claim 9, wherein the localizer comprises a Global Navigation Satellite System (GNSS) localizer.

11. The computer-implemented method of claim 8, wherein the calibration robot includes an optical calibration target, and wherein the first set of sensor data comprises Light Detection and Ranging (LiDAR) sensor data for the optical calibration target.

12. The computer-implemented method of claim 8, wherein the calibration robot includes an optical calibration target, and wherein the first set of sensor data comprises camera sensor data for the optical calibration target.

13. The computer-implemented method of claim 8, further comprising:
determining one or more extrinsic calibration parameters for the one or more AV sensors based on the first set of sensor data and the first location of the calibration robot.

14. The computer-implemented method of claim 8, further comprising:
determining one or more extrinsic calibration parameters for the one or more AV sensors based on the second set of sensor data and the second location of the calibration robot.

15. A non-transitory computer-readable storage medium comprising at least one instruction for causing a computer or processor to:
determine a first location of a calibration robot within a calibration environment;
collect, using one or more autonomous vehicle (AV) sensors, a first set of sensor data for the calibration environment, wherein at least a portion of the first set of sensor data represents the calibration robot at the first location;
transmit a relocation command to the calibration robot, wherein the relocation command specifies a second location within the calibration environment, and wherein the relocation command causes the calibration robot to navigate to the second location; and
collect, using the one or more AV sensors, a second set of sensor data for the calibration environment, wherein the second set of sensor data includes the calibration robot at the second location.

16. The non-transitory computer-readable storage medium of claim 15, wherein the first location of the calibration robot is based on localization information provided by a localizer disposed on the calibration robot.

17. The non-transitory computer-readable storage medium of claim 16, wherein the localizer comprises a Global Navigation Satellite System (GNSS) localizer.

18. The non-transitory computer-readable storage medium of claim 15, wherein the calibration robot includes an optical calibration target, and wherein the first set of sensor data comprises Light Detection and Ranging (LiDAR) sensor data for the optical calibration target.

19. The non-transitory computer-readable storage medium of claim 15, wherein the calibration robot includes an optical calibration target, and wherein the first set of sensor data comprises camera sensor data for the optical calibration target.

20. The non-transitory computer-readable storage medium of claim 15, wherein the at least one instruction is further configured to:
determine one or more extrinsic calibration parameters for the one or more AV sensors based on the first set of sensor data and the first location of the calibration robot.
